(19) United States
(12) Patent Application Publication
(10) Pub. No.: US 2018/0152736 A1
(43) Pub. Date: May 31, 2018

(54) LIVE VIDEO RECORDING, STREAMING, VIEWING, AND STORING MOBILE APPLICATION, AND SYSTEMS AND METHODS OF USE THEREOF

(71) Applicant: Harold Glen Alexander, Smyrna, GA (US)

(72) Inventor: Harold Glen Alexander, Smyrna, GA (US)

(21) Appl. No.: 15/725,230

(22) Filed: Oct. 4, 2017

Related U.S. Application Data
(60) Provisional application No. 62/428,472, filed on Nov. 30, 2016.

(51) Int. Cl. H04N 21/2187; H04N 21/218; H04N 21/482

(52) U.S. Cl. CPC H04N 21/2187; H04N 21/23418; H04N 21/482; H04N 21/21805

(57) ABSTRACT

A system, method, or computer program product adapted to record, transmit, view, and store a plurality of live audiovisual content from a live event. The system may include one or more mobile devices, one or more remotely-controlled aerial systems, one or more servers, a network, and a mobile application installed on the one or more mobile devices. The mobile application may include a graphical user interface adapted to initialize a camera and microphone on a mobile device or remotely-controlled aerial system, transmit live audiovisual content recorded with the camera and microphone to a server, receive a plurality of live audiovisual content from a server, and receive input from a user of the mobile application to change the arrangement of live audiovisual content displayed on the mobile device. The server may include an algorithm adapted to evaluate and rank the live audiovisual content transmitted to the server from a plurality of users of the mobile application, and the graphical user interface of the mobile application may include an automatic mode adapted to automatically arrange the live audiovisual content displayed on the mobile device based on rankings determined by the algorithm.

### CROSS-REFERENCE TO RELATED APPLICATIONS

This application claims the benefit of the following provisional application, which is hereby incorporated by reference in its entirety: Application No. 62/428,472, UNDERGROUND APP LIVE VIDEO STREET DIRECTOR, filed Nov. 30, 2016 by Harold Glen Alexander.

### TECHNICAL FIELD

The subject disclosure relates to applications, systems, and methods used to “stream,” that is, digitally record and simultaneously transmit, live video and audio, or together “audiovisual,” content. More particularly, the present disclosure relates to a mobile application, systems, and methods which allow a plurality of in-person spectators to simultaneously record and transmit, or “stream,” digital images and sounds from live events, using mobile devices, while allowing other in-person and remote spectators to select from and observe a plurality of audiovisual content from the same live event. Using the mobile application, systems, and methods of the subject disclosure, a plurality of mobile and desktop device users can enjoy a manually customized, or automatically optimized, spectator experience with minimal training and negligible delay compared to audiovisual content provided by professional photographers, videographers, directors, editors, broadcasters, and other media providers.

### BACKGROUND

Ever since mobile devices equipped with cameras and video recording capabilities were made commercially available, consumers have sought to instantaneously capture and record their daily lives. With the advent of social media, consumers have similarly come to expect and enjoy the ability to immediately share with others their photographs and live video content, which in modern understanding includes the synchronized audio content associated with the video content. Most recently, the rise of live sharing or “streaming,” i.e. the simultaneous recording and transmittal of live audiovisual content, has provided consumers with perhaps the most immediate means fathomable to broadcast their experiences, and often their opinions about them, to others in real time. This phenomenon has whetted consumers' appetites for all kinds of “shared experiences,” especially when financial, temporal, spatial, or geographic limitations would otherwise prevent some consumers from enjoying these experiences at all.

For example, limited space at even the largest concert venues means that only a finite number of spectators will be able enjoy a given concert live and in-person. Furthermore, only a small subset of those patrons will be close enough to the stage to see the performers without the aid of the venue's video screens or binoculars, and they will likely be too far away to capture clear photographs or video of the performers. As a result, a consumer's only access to the live, in-person, and up-close experience at live performances, such as concerts, sporting events, and press conferences, may come at the cost of high ticket prices or other prohibitive costs of entry, which may be exacerbated by fees and charges on the secondary ticket market. It would be advantageous to identify new applications, systems, and methods that would provide the up-close and personal experience, currently only available to a select few, to a wider, perhaps innumerable, audience of spectators and fans.

At the same time, society's continued demand for customizable and on-demand entertainment requires that those who consume live video and audio content, from now on referred to together simply as “live video content,” as the associated and synchronized live audio content has become an expected facet of live video content, are in the driver's seat when selecting from which angles to view the world. As there are often countless parties discussing the same subjects on multitudes of Internet video websites and podcasts, the consumer has become accustomed to cherry-picking the content of their choice, based on factors ranging from a video or podcast expressing views similar to the viewer's own, to one video or podcast simply having better video or audio quality, to a particular recording having captured an optimal viewpoint compared to other videos of the same newsworthy or popular event.

This power of choice and customization, as well as the unmet demand for seeing the clearest view of what's happening without awaiting professionally edited and censored content after-the-fact, has caused consumers to prefer immediate access to multiple points of view, both spatially and ideologically, rather than being satisfied with one, such as that provided by network news or official coverage of live events. As a result, it would be advantageous to identify applications, systems, and methods that would allow spectators to tailor their viewing experience of what others record and transmit, or “stream,” along with the option to automatically see the highest quality coverage available of a live event.

### SUMMARY

The present disclosure overcomes one or more deficiencies of the prior art. In particular, the mobile application, systems, and methods of the subject disclosure may provide a more flexible, customizable, and optimizable shared live audiovisual content streaming and viewing experience that the current state of the art. The mobile application, systems, and methods of the subject disclosure may merge a plurality of live audiovisual content recorded and transmitted, that is, “streamed,” from the same live event, such as, e.g., a concert, sports event, press conference, training exercise, film production, or other performance, by spectators, that is, “streamers,” using the mobile application on mobile devices, such as, e.g., smartphones, tablet computers, wristwatch style or otherwise wearable devices, or remotely-controlled aerial systems, commonly known as “drones,” at a single location into one or more collections of streamed live audiovisual content. Streamers may use the mobile application of the subject disclosure to view live audiovisual content streamed from other streamers, including live audiovisual content recorded and transmitted, or “streamed,” by remotely-controlled aerial systems or “drones,” which may record a live event from a wider range of altitudes and angles than those possible by streamers on the ground using mobile devices.

In addition, in-person viewers, that is, spectators physically attending the live event but not recording live audiovisual content, may use mobile devices, such as, e.g., smartphones, tablet computers, wristwatch-style or otherwise wearable computers, or other portable Internet-connected computing devices, to view live audiovisual content streamed by streamers using the mobile application of the subject disclosure. Similarly, remote viewers, that is, spectators not physically present at the live event and thus not recording live video content of the live event, may use a desktop device, such as, e.g., a personal computer or laptop computer, to access a website version of the mobile application of the subject disclosure to view streamed live audiovisual content. Alternatively, remote viewers may also use a mobile device to view streamed live audiovisual content, as described above for in-person viewers.

Furthermore, in-person viewers and remote viewers alike may use a graphical user interface, commonly referred to as a “GUI” or “gooey,” of the mobile application of the subject disclosure to manually select between a plurality of streamed live audiovisual content, that is, “streams” or “video streams,” to be displayed in a preferred or predetermined area of the GUI, or allow the mobile application to automatically select and display optimal live audiovisual content from among the available live audiovisual streams, such as, e.g., by using an algorithm to rank the available live audiovisual streams based on predetermined characteristics or criteria, such as, e.g., video quality; audio quality; audio volume; preferred angles or viewpoints, such as, e.g., high-altitude footage recorded by remotely-controlled aerial systems or “drones;” the location of persons and objects at the live event, such as, e.g., celebrities, players, and the ball itself at a live sporting event; and availability of streamed content from certain streamers, such as, e.g., celebrities or spectators with on-stage or backstage access to the live event, in a preferred or predetermined area of the GUI.

Optimal audiovisual content from each interval of the live event, as determined by the algorithm, may be aggregated and merged into an optimal or “master” recording of the entire live event. This master recording may be stored on a server and made available to streamers, viewers, and remote viewers who may gain authorized access to the server, and subsequently the master recording, after the live event has ended, such as, e.g., through a subscription or membership service. Streamers may receive additional incentives to stream live audiovisual content at live events, such as, e.g., being able to save a digital copy of audiovisual content recorded by other streamers, such as, e.g., streamers that recorded audiovisual content using remotely-controlled aerial systems or “drones,” in addition to being able to view and store the master recording described above on a mobile or desktop device.

In-person viewers and remote viewers may use the mobile application of the subject disclosure to record and store still photographs, commonly known as “screenshots” or “screen captures,” of streamed live audiovisual content while viewing live audiovisual streams transmitted to their mobile or desktop devices using the mobile application of the subject disclosure. In-person viewers and remote viewers may also use the mobile application of the subject disclosure to pause or rewind streamed live audiovisual content, such as, e.g., by using manual or voice-activated features of a graphical user interface of the mobile application of the subject disclosure. In addition, streamers, in-person viewers, and remote viewers may be able to communicate with other streamers, in-person viewers, and remote viewers using the mobile application of the subject disclosure by any suitable means known in the art, such as, e.g., short-message service, commonly known as “SMS” or “texting;” group messaging applications; or ideogrammatic communication methods, such as, e.g., emojis, emoticons, or other image-based communication tools.

Currently available devices, systems, applications, and methods known in the art may only allow users to either record and transmit live audiovisual content, or, alternatively, view live audiovisual content, at one time. Furthermore, a user of existing devices, applications, systems, and methods known in the art may not be able to simultaneously “stream” live audiovisual content while viewing live audiovisual content transmitted by a plurality of other streamers. As such, the current state of the art does not provide the flexibility to both provide crowdsourced video content while viewing crowdsourced video content from other users. Advantageously, the mobile application of the subject disclosure may be adapted to record and transmit, or “stream,” live audiovisual content while simultaneously receiving a plurality of live audiovisual content streamed by other users of the mobile application of the subject disclosure.

Furthermore, the current state of the art does not enable a user to manually or automatically toggle between available live audiovisual streams in a single graphical user interface on a variety of mobile and desktop devices in a streamlined manner, such as, e.g., by using a manual, voice-activated, or automated system to switch to streamed live audiovisual content of a speaker, performer, or athlete based on predetermined characteristics or criteria of the streamed live audiovisual content when compared to a plurality of other live audiovisual content streamed from the same live event by other users.

By contrast, an advantage of the mobile application, systems, and methods of the subject disclosure may be to provide users the flexibility to manually select a live audiovisual stream, from among a plurality of streamed live audiovisual content, to be displayed in a preferred area of a graphical user interface, by manually touching the streamed live audiovisual content as displayed in a GUI, or by verbally indicating which live audiovisual stream should be toggled to display in a preferred area of the GUI. Additionally, the mobile application, systems, and methods of the subject disclosure may allow a user to enable an automatic mode of the mobile application, which may automatically toggle optimal streamed live audiovisual content, as determined by an algorithm, to be displayed in a preferred area of the GUI, by comparing predetermined characteristics or criteria, such as, e.g., video quality; audio quality; audio volume; preferred angles or viewpoints, such as, e.g., high-altitude footage recorded by remotely-controlled aerial systems or “drones;” the location of persons and objects at the live event, such as, e.g., celebrities, players, and the ball itself at a live sporting event; and availability of streamed content from certain streamers, such as, e.g., celebrities or spectators with on-stage or backstage access to the live event.

Accordingly, the manual or automatic customization and precision possible using the mobile application, systems, and methods of the subject disclosure may provide an advantage for a more enjoyable viewing experience for both in-person and remote spectators, as well as higher quality streamed live audiovisual content. In addition, the manual or automatic compilation of optimal streamed live audiovisual content made possible by the mobile application, systems, and methods of the subject disclosure would provide a finished product “crowdsourced” instantly by a plurality of spectators, without the need for professional training, and at a lower cost. The mobile application, systems, and methods of the subject disclosure may provide a more satisfying social or cooperative experience than patrons and fans having to wait days or longer for audiovisual content from the event that may be heavily edited, censored, shortened, or altered by a single video director or video editor providing a finalized video, using only predetermined or director-chosen viewpoints, and at a much higher cost. These limitations of the current state of the art fail to accommodate the intended uses of “streamed” audiovisual content of live performances and events, but the mobile application, systems, and methods of the subject disclosure may overcome these limitations.

The mobile application, systems, and methods of the subject disclosure would allow each user to customize the audiovisual content “streaming” and viewing experience, rather than merely observe the recorded, transmitted, and broadcast content of a single professional director or editor with access to the live event. In addition, the mobile application, systems, and methods of the subject disclosure may a much more reusable, portable, and economical alternative to formal video recording and broadcasting equipment and systems. Overall, the mobile application, systems, and methods of the subject disclosure may provide the flexibility of simultaneous live audiovisual content streaming and viewing, and immediately available optimized master recordings of live events created from widely crowdsourced audiovisual content, with significantly less training, cost, and delay.

A mobile application of the subject disclosure may be adapted to record and transmit live audiovisual content as part of a system of hardware and software. The mobile application may include a graphical user interface, a mobile device feature interface, and a mobile application icon. The graphical user interface, commonly known as a “GUI” or “gooey,” may include a primary video panel, a plurality of secondary video panels, a plurality of live video streams, an online user panel, and an advertisement panel. The system of hardware and software may include the mobile application, a plurality of mobile devices, a plurality of cameras connected to the plurality of mobile devices, a plurality of remotely-controlled aerial systems, a plurality of aerial cameras connected to the plurality of remotely-controlled aerial systems, a network, a server, a plurality of desktop devices, and a website.

A system of the subject disclosure may be adapted to record, transmit, view, and store live audiovisual content from a live event. The system may include one or more computing devices, such as, e.g., mobile devices and desktop devices; one or more remotely-controlled aerial systems, one or more servers, one or more networks, and the mobile application described above. The mobile device, such as, e.g., a smartphone, tablet computer, wristwatch-style or otherwise wearable computer, or other portable Internet-connected computing device, may include a mobile device display area and a speaker on a front side, and a camera, a flash, and a microphone on a back side. The mobile application may be installed on the mobile device, and the mobile application may use the mobile device feature interface to manipulate the camera, flash, microphone, speaker, and network connection utilities on the mobile device. The remotely-controlled aerial system, also known as an unmanned aerial vehicle or “drone,” may include aerial camera. The mobile application installed on the mobile device may be used to manipulate the remotely-controlled aerial system and an aerial camera connected to the remotely-controlled aerial system.

The network may include any suitable devices or means known in the art, such as, e.g., computer hardware, software, or firmware adapted to transmit data by analog or digital signals by and between computing devices. The mobile application may communicate with the server by way of the network to transmit and receive streamed live audiovisual content or other data. The server may include an algorithm and a data storage. The algorithm may evaluate streamed live audiovisual content and assign a ranking, such as, e.g, a “video quality number,” to streamed live audiovisual content based on predetermined characteristics or criteria of the streamed live video content. The data storage may be any suitable devices or mean known in the art adapted to secure digital data for later use, and it may include a plurality of user profiles and a plurality of master video files. The user profiles may include information about authorized users of the mobile application and their preferences for using the mobile application of the subject disclosure. The master video files may be one or more compilations of optimal audiovisual content from a live event, as selected by the algorithm from among a plurality of streamed live audiovisual content from the same live event, stored for later use by users of the mobile application.

The desktop device, such as, e.g., a personal computer or laptop computer, may include a desktop device display area, a desktop pointing device, a desktop device display area position indicator, a desktop typing device, and a network connection. The desktop device display area, such as, e.g., a computer monitor screen, may be adapted to display visual data, such as the website, to a remote user. The desktop pointing device, such as, e.g., a computer mouse or computer pen, may be adapted to provide user input to the desktop device, such as, e.g., to direct the desktop device to display the website, or to navigate the graphical user interface. The desktop device display area position indicator, such as, e.g., a computer screen cursor, may be adapted to provide user input to the desktop device, such as, e.g., to direct the desktop device to display the website, or to operate the graphical user interface, based on the relative location of features of the graphical user interface displayed on the desktop device display area.

The desktop typing device, such as, e.g., a computer keyboard, may be adapted to provide user input to the desktop device, such as, e.g., to direct the desktop device to display the website, or to operate the graphical user interface. The network connection may be adapted to enable the desktop device to communicate with the server by way of a network, such as, e.g., the Internet. The website may be an Internet browser-based version of the mobile application of the subject disclosure, and may include a graphical user interface, a performance information panel, a sponsor information panel, and an advertisement panel. The website may receive streamed live audiovisual content from the server by communicating with the server by way of the network connection accessing the network, such as, e.g., by way of the Internet.

A method of recording and transmitting, or “streaming,” live audiovisual content from a live event, such as, e.g., a concert, sporting event, press conference, or other live performance, may comprise a user or “streamer” initializing the mobile application on a mobile device; the mobile application establishing a connection to a server; the mobile application authenticating the streamer and streamer's settings; the mobile application determining the streamer's location, such as, e.g., longitude, latitude, and altitude coordinates; the streamer initializing a live stream feature of the mobile application on the mobile device; the mobile application initializing a camera on the mobile device, such as, e.g., by using the mobile device feature interface; the streamer recording live audiovisual content; the mobile application compressing and buffering the live audiovisual content; the mobile application transmitting the buffered live audiovisual content to a server; the server authenticating the streamed live audiovisual content; the server decompressing the streamed live audiovisual content; an algorithm on the server performing one or more quality checks on the streamed live audiovisual content and assigning a ranking, such as, e.g., a “video quality number,” to the streamed live audiovisual content; the server merging streamed live audiovisual content with other live audiovisual content streamed by other streamers at the same location or live event; the server transmitting streamed live audiovisual content to other streamers and viewers at the same location or live event, and to remote viewers, until the streamer terminates the mobile application; and the server storing a master video file using the highest quality audiovisual content at each interval of the live event, as selected by the algorithm from all live audiovisual content streamed from the live event.

A method of viewing streamed live audiovisual content from a live event, such as, e.g., a concert, sporting event, press conference, or other live performance, may comprise a viewer logging into the mobile application, or a remote viewer logging into an Internet browser-based version of the mobile application or “website;” the mobile application authenticating the viewer, or the website authenticating the remote viewer; the viewer or remote viewer selecting a live stream location or live event from a plurality of live stream locations or live events; a server compressing live stream audiovisual content from the live stream location or live event; an algorithm assigning numbers, such as, e.g., “video quality numbers,” to live streamed audiovisual content from the live stream location or live event; the server transmitting live audiovisual streams from all streamers at the live stream location or live event as thumbnail videos; the mobile application or website receiving the thumbnail videos with respective rankings or “video quality numbers;” the mobile application or website ranking the thumbnail videos based on the video quality numbers; the mobile application or website decompressing the live audiovisual streams; the mobile application or website checking whether or not the viewer or remote viewer, respectively, has enabled an automatic mode of the mobile application: if not, the viewer or remote viewer selecting a thumbnail video to display in a primary video panel, and if so, the mobile application or website automatically displaying the thumbnail with the highest video quality number in the primary video panel; and the mobile application or website displaying streamed live audiovisual content in primary and secondary video panels in a graphical user interface of the mobile application of the subject disclosure.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates front and back views of a live video recording system using the mobile application, systems, and methods of the subject disclosure with a mobile device, in conjunction with some combination of the mobile device's camera, flash, and microphone; and a front view of a remotely-controlled aerial system equipped with an aerial camera.

FIG. 2 is a schematic diagram illustrating a live video recording, streaming, viewing, and storing system using the mobile application, systems, and methods of the subject disclosure, in conjunction with a plurality of mobile and desktop devices, a plurality of remotely-controlled aerial systems, a server, and a network.

FIG. 3 illustrates a front view of a live video streaming system featuring a plurality of streamers recording, streaming, and viewing a live event with a plurality of mobile devices using the mobile application, systems, and methods of the subject disclosure.

FIG. 4 illustrates a front view of a live video viewing system using the mobile application, systems, and methods of the subject disclosure, in conjunction with a graphical user interface displayed on a mobile device.

FIG. 5 illustrates a front view of a live video remote viewing system using an Internet browser-based or website version of the mobile application, systems, and methods of the subject disclosure, in conjunction with a graphical user interface displayed on a desktop device.

FIG. 6 illustrates a flow chart diagram of a method of recording and transmitting, or “streaming,” a plurality of live video content using the mobile application and systems of the subject disclosure, in conjunction with a plurality of mobile devices.

FIG. 7 illustrates a flow chart diagram of a method of viewing a plurality of live video content by a viewer at the location of the live event, using the mobile application and systems of the subject disclosure, or by a remote viewer not present at the location of the live event, using a website version of the mobile application and systems of the subject disclosure.

### DETAILED DESCRIPTION

Particular embodiments of the present invention will now be described in greater detail with reference to the figures.

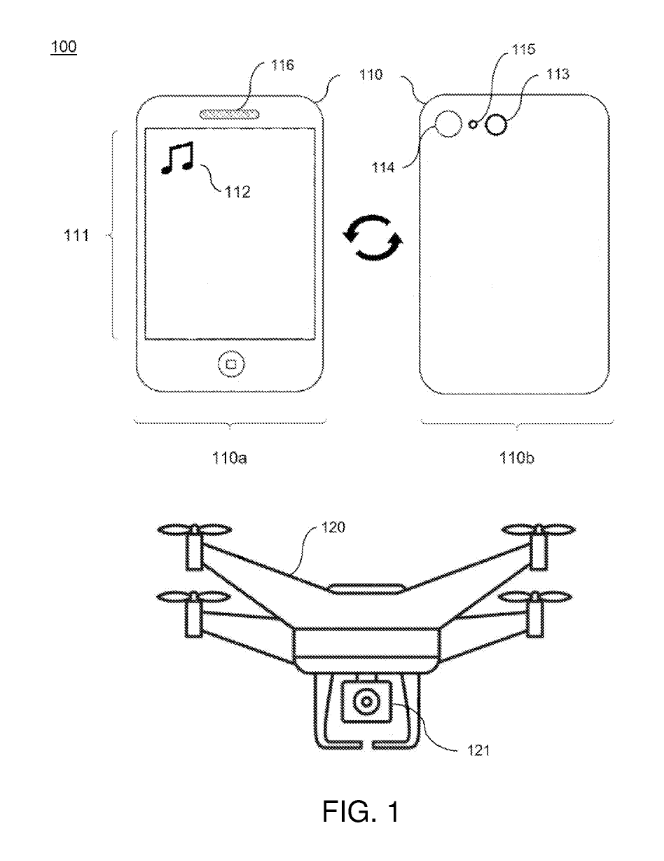

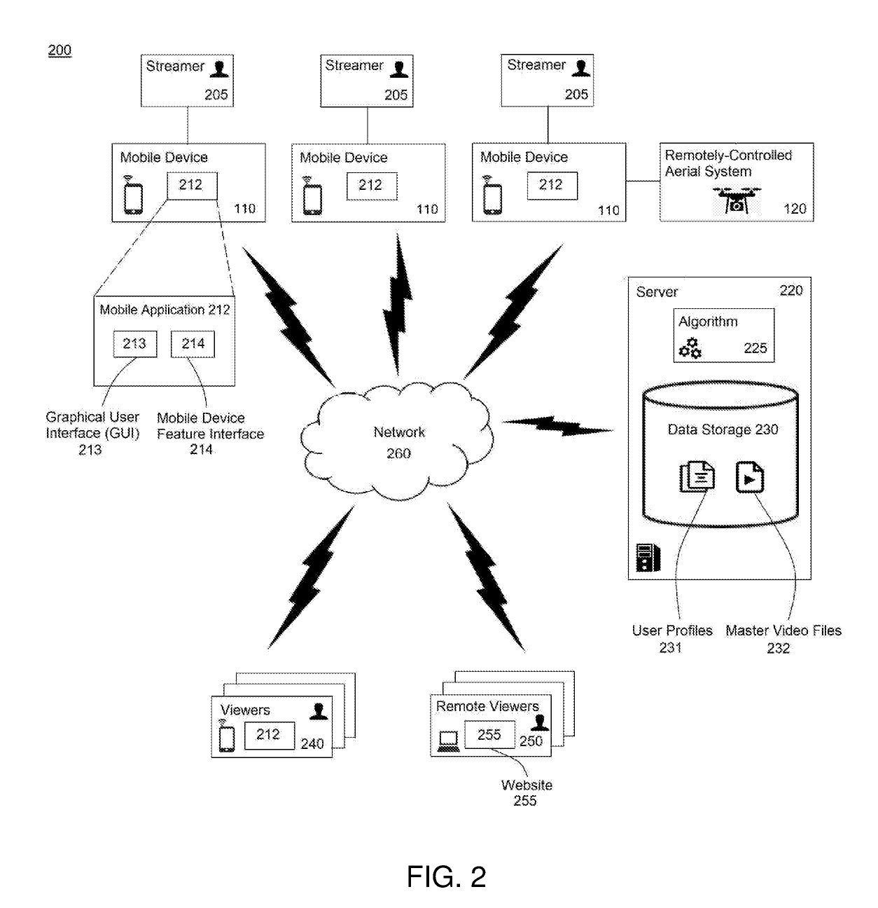

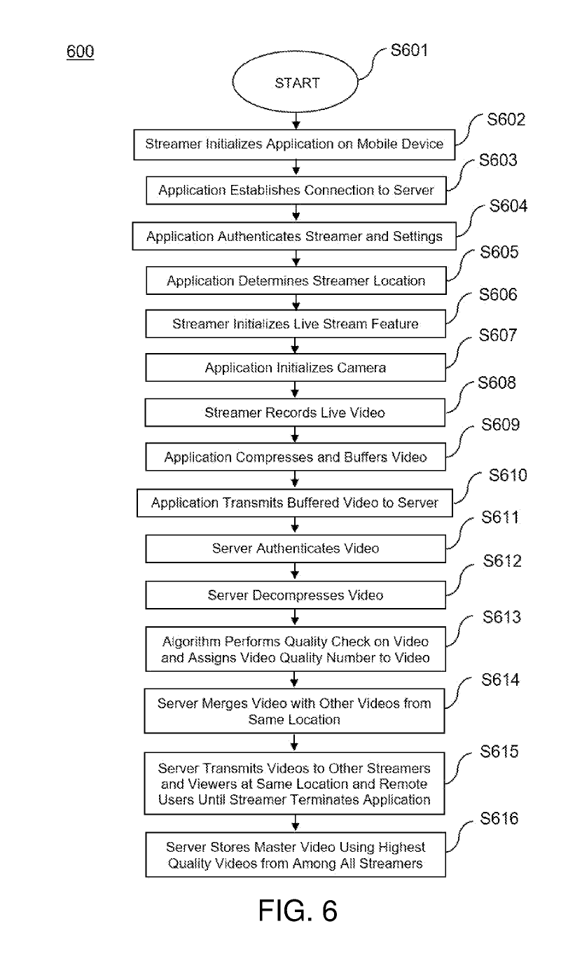

FIG. 1 illustrates front and back views of a live video recording system 100 using mobile application 212, as explained in FIG. 2, and method 600, as explained in FIG. 6, of the subject disclosure, in conjunction with a mobile device 110 and a camera 113. Mobile device 110, which may be any suitable device known in the art, such as, e.g., a smartphone, tablet computer, wristwatch-style or otherwise wearable computer, or other portable Internet-connected computing device, may include a front side 110a, a back side 110b, a mobile device display area 111, a mobile application icon 112, a camera 113, a flash 114, a microphone 115, and a speaker 116.

Mobile device display area 111 may be any suitable device known in the art, such as, e.g., a surface capacity touchscreen, a resistive touchscreen, or other screen adapted to respond to operator input, such as, e.g., input by hand, stylus, or verbal command, and display visual output to an operator. Camera 113 may be any suitable device known in the art that is adapted to capture still photography or record video content, such as, e.g., a smartphone camera, and flash 114 may be any device known in the art adapted to alter properties of still photography or video content captured by camera 113, such as, e.g., lighting, brightness, or color saturation.

Microphone 115 may be any suitable device known in the art adapted to record audio content, such as, e.g., a smartphone microphone adapted to record audio content synchronized to video content recorded by camera 113 or receive verbal commands from an operator in conjunction with voice-operated features of mobile device 110. Speaker 116 may be any suitable device known in the art adapted to transmit audio content to an operator from mobile device 110, such as, e.g., a smartphone speaker or headphones.

An operator, or “streamer” 205 as explained in FIG. 2, may initialize mobile application 212 by any suitable method known in the art, such as, e.g., by manually or with a stylus pressing an area of mobile device display area 111, such as, e.g., on a smartphone “home screen,” on front side 110a, represented by mobile application icon 112. Alternatively, streamer 205 may use verbal commands, in conjunction with a voice-operated feature of mobile application 212 or mobile device 110, to select and initialize mobile application 212. Once initialized, mobile application 212 of the subject disclosure may prompt streamer 205 to indicate the location or live event from which streamer 205 intends to record, transmit, or together “stream,” or view live video content, or any combination of these actions, in any suitable manner known in the art, such as, e.g., by listing predetermined locations or live events saved on a server 220, as explained in FIG. 2, connected to mobile application 212, or by mobile application 212 accessing location data, such as, e.g., latitude, longitude, and altitude coordinates, from a global positioning satellite or “GPS” utility installed on mobile device 110, using a mobile device feature interface 214, explained in FIG. 2, to list nearby locations or live events.

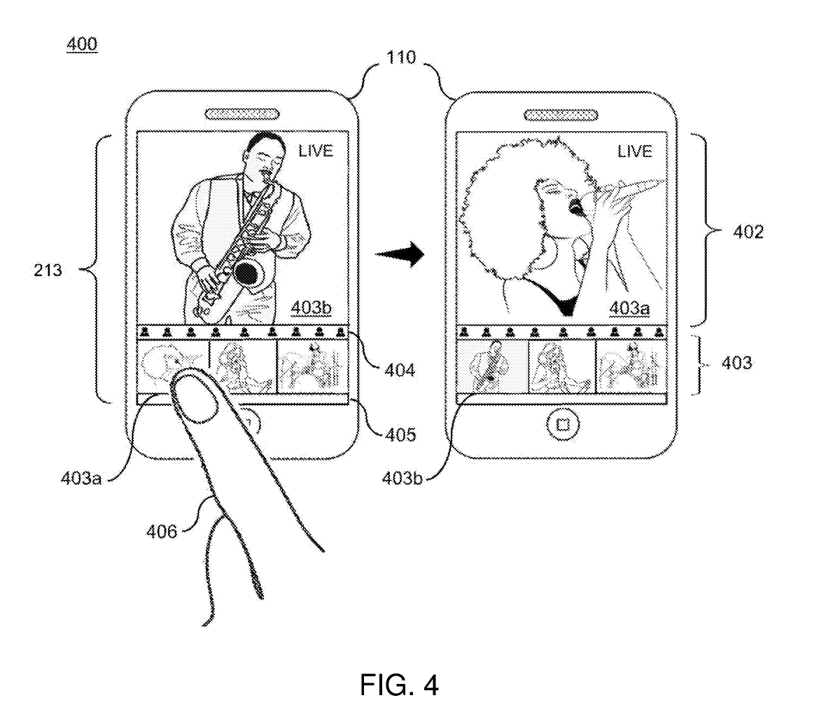

Once streamer 205 selects a location or live event, mobile application 212 may launch a graphical user interface 213 of mobile application 212, as explained in FIGS. 2 and 4, which may subsequently initialize camera 113, flash 114, and microphone 115, on back side 110b of mobile device 110, which may subsequently be used to record and transmit, or “stream,” live video content according to method 600, as explained in FIG. 6. Speaker 116, on front side 110a of mobile device 110 may be used to hear audio content, such as, e.g., audio cues related to the navigation of graphical user interface 213, provided by mobile application 212 on mobile device 110.

In another embodiment, mobile application 212 installed on mobile device 110 may be used to initialize one or more camera and microphone assemblies 121, or “aerial cameras,” on one or more remotely-controlled aerial systems 120, which may be any suitable devices known in the art, such as, e.g., devices of various sizes commonly referred to as “drones” or “unmanned aerial vehicles.” Remotely-controlled aerial systems 120 may enable streamers 205 to record and transmit, or “stream,” live video content from a wider range of altitudes and angles than possible by streamers 205 on the ground using mobile devices 110, using mobile application 212 of the subject disclosure in conjunction with mobile devices 110.

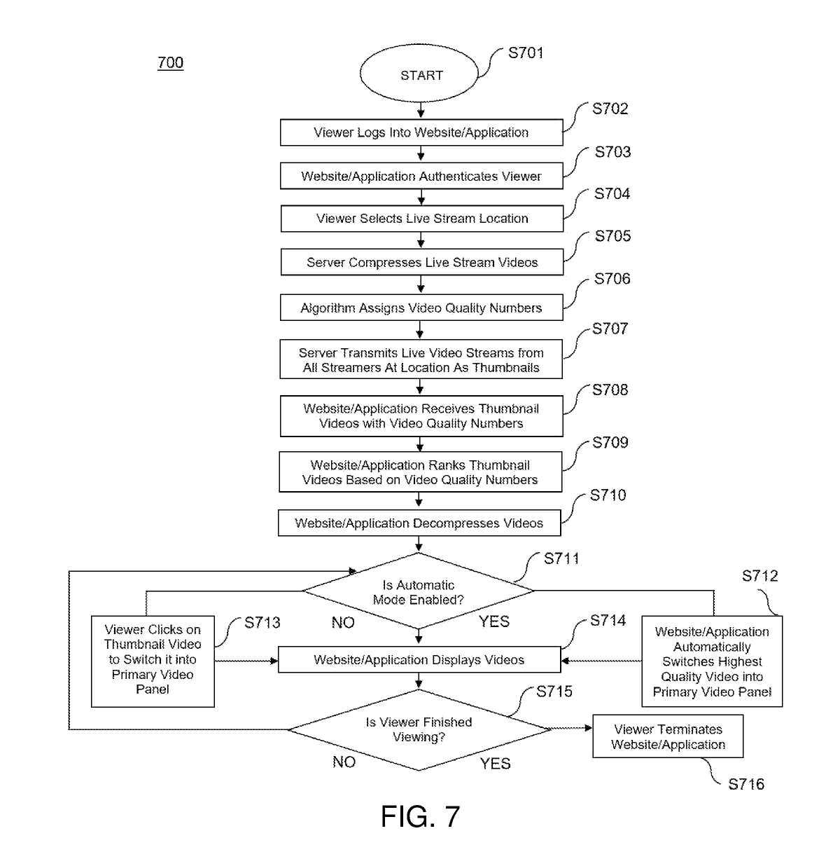

FIG. 2 is a schematic diagram illustrating a live video recording, streaming, viewing, and storing system 200 using mobile application 212 and methods 600 and 700 of the subject disclosure, as explained in FIGS. 6 and 7. System 200 may include a plurality of operators, or “streamers” 205, using a plurality of mobile devices 110 equipped with mobile application 212, one or more remotely-controlled aerial systems 120 controlled by one or more of mobile devices 110, a network 260, a server 220, a plurality of viewers 240 using mobile application 212, and a plurality of remote viewers 250 using a website 255. Mobile application 212 may include a graphical user interface 213, as explained in FIG. 4, and a mobile device feature interface 214. Server 220 may include an algorithm 225 and a data storage 230, which may include user profiles 231 and master video files 232.

A plurality of streamers 205 may use the plurality of mobile devices 110, which may be equipped with mobile application 212. Upon streamer 205 initializing mobile application 212, mobile application 212 may launch graphical user interface 213, which may illustrate and provide control over available features of mobile application 212 to streamer 205 in any suitable manner known in the art, such as, e.g., by displaying a plurality of visual elements on mobile device display area 111 of mobile device 110, as explained in FIGS. 1 and 4. Streamer 205 may interact with graphical user interface 213 in any suitable manner known in the art, such as, e.g., by using a pointing implement 406, such as, e.g., a finger or stylus, as explained in FIG. 4, or verbally, using voice-activated command utilities that may be enabled on mobile device 110.

In response to input from streamer 205, mobile application 212 may leverage mobile device feature interface 214 to initialize features installed on mobile device 110, such as, e.g., a global positioning satellite or “GPS” utility; network connection utilities; camera 113, flash 114, microphone 115, and speaker 116; or other mobile applications installed on mobile device 110, which may be used to initialize and maneuver other devices, such as, e.g., a one or more remotely-controlled aerial systems 120 and one or more camera and microphone assemblies 121 connected to the one or more remotely-controlled aerial systems 120.

Plurality of streamers 205 may record live audiovisual content by using cameras 113 and microphones 115 on mobile devices 110, or, alternatively, by using camera and microphone assemblies 121 on remotely-controlled aerial systems 120 that are controlled by mobile devices 110. Mobile application 212 may transmit live video content from streamers 205 to server 220, and receive live video content from other streamers 205 at the same location or live event that is aggregated or merged by server 220, by way of a network 260. Network 260 may include any suitable devices or means known in the art, such as, e.g., computer hardware, software, or firmware adapted to transmit data by analog or digital signals by and between computing devices.

Server 220 may be any suitable device, means, or embodiment known in the art, such as, e.g., a physical computer server or a cloud computing server. Server 220 may authenticate the identity of streamers 205 and the authorization, if any, of streamers 205 to access server 220 in any suitable manner known in the art, such as, e.g., by comparing information provided by or about streamers 205, such as, e.g., user login information, transmitted by mobile application 212 on mobile device 110 to information saved as user profiles 231 in data storage 230 on server 220, or by any suitable biometric authentication method known in the art, such as, e.g., fingerprint or facial recognition. Server 220 may also authenticate, compress, and decompress live video content to facilitate the transmission of live video content from streamers 205, and to streamers 205, viewers 240, and remote viewers 250, as explained in FIGS. 6 and 7.

Server 220 may initialize algorithm 225, which may be adapted to evaluate and compare predetermined characteristics or criteria of live video content recorded by streamers 205 in order to assign a ranking, such as, e.g., a “video quality number,” to the live video content. Algorithm 225 may evaluate and compare any suitable characteristics or criteria known in the art, such as, e.g., video quality; audio quality; audio volume; preferred angles or viewpoints, such as, e.g., high-altitude footage recorded by remotely-controlled aerial systems 120 or “drones;” the location of persons and objects at the live event, such as, e.g., celebrities, players, and the ball itself at a live sporting event; and availability of streamed content from certain streamers 205, such as, e.g., celebrities or spectators with on-stage or backstage access to the live event. Server 220 may subsequently store the highest quality live video content in any suitable manner known in the art, such as, e.g., live video content with the highest video quality numbers at each interval of a live event, as determined by algorithm 225, being stored for later use as a one or more master video files 232 in data storage 230 on server 220.

In one embodiment, server 220 may instantaneously transmit, by way of network 260, live video content with the highest video quality numbers from a live event to streamers 205, viewers 240, and remote viewers 250, so that mobile application 212 may display live video content with the highest video quality numbers at any given moment in primary video panel 402 of graphical user interface 213 on mobile device display area 111 of mobile devices 110, as explained in FIG. 4. Mobile application 212 may display live video content with progressively lower video quality numbers in one or more secondary video panels 403 of graphical user interface 213 in a smaller format, such as, e.g., “thumbnail” videos.

As explained in FIGS. 4 and 7, streamers 205, viewers 240, and remote viewers 250 that enable a feature, which may be referred to as an “automatic mode” or “optimal mode,” of mobile application 212 that may automatically display live video content with the highest available video quality numbers, at any given moment, in primary video panel 402, may view live video content that is rated the highest by algorithm 225 in primary video panel 402 at each interval of the live event.

In addition, the “automatic mode” or “optimal mode” may include an “event mode,” which may be adapted to display live video content based on predetermined metrics, such as, e.g., spatial and temporal indicators, of certain kinds of live events. In one example, the “event mode” of mobile application 212 may be adapted to show live video content from a live baseball game, of a baseball pitcher during the motion of throwing a pitch in primary video panel 402, and then, at an appropriate and predetermined time, automatically toggle primary video panel 402 to display live video content of a baseball batter during the motion of swinging at the same pitched ball. The appropriateness of a certain viewpoint may be factored into the ranking assigned to a live video stream by algorithm 225. In this example, spatial indicators associated with this kind of live event, a baseball game, may be the pitcher's mound, the batter's box, and the spectator area, among other locations that may provide live video content relevant to viewers 240 and remote viewers 250.

Temporal indicators in this example may include the moment at which a pitch is thrown, and this instant of time may be used by the “event mode” of mobile application 212 as a trigger signaling when primary video panel 402 may toggle from live video content of the pitcher to live video content of the batter. In addition, a temporal indicator associated with the “7th inning stretch” may be used by the “event mode” of mobile application 212 as a trigger signaling when primary video panel 402 may toggle from displaying live video content of the baseball field to live video content of the spectator area. As a result, viewers 240 and remote viewers 250 may be able to view the live event in a similar fashion to in-person viewers, and, as explained in FIGS. 2 and 6, master video files 232, which may include one or more compilations of the live video content with the highest available video quality numbers and most appropriate viewing angles at each interval of the baseball game, may be saved in data storage 230 on server 220 for later viewing by streamers 205, viewers, 240, and remote viewers 250.

By contrast, streamers 205, viewers 240, and remote viewers 250 that disable the “automatic mode” or “optimal mode,” and “event mode,” of mobile application 212 may choose which from among a plurality of live video content, displayed in one or more secondary video panels 403, will be displayed in primary video panel 402 by any suitable manner known in the art, such as, e.g., by using a pointing implement 406, such as, e.g., a finger or stylus, or verbally, using voice-activated command features that may be enabled on mobile device 110, to select particular live video content, as explained in FIGS. 4 and 7.

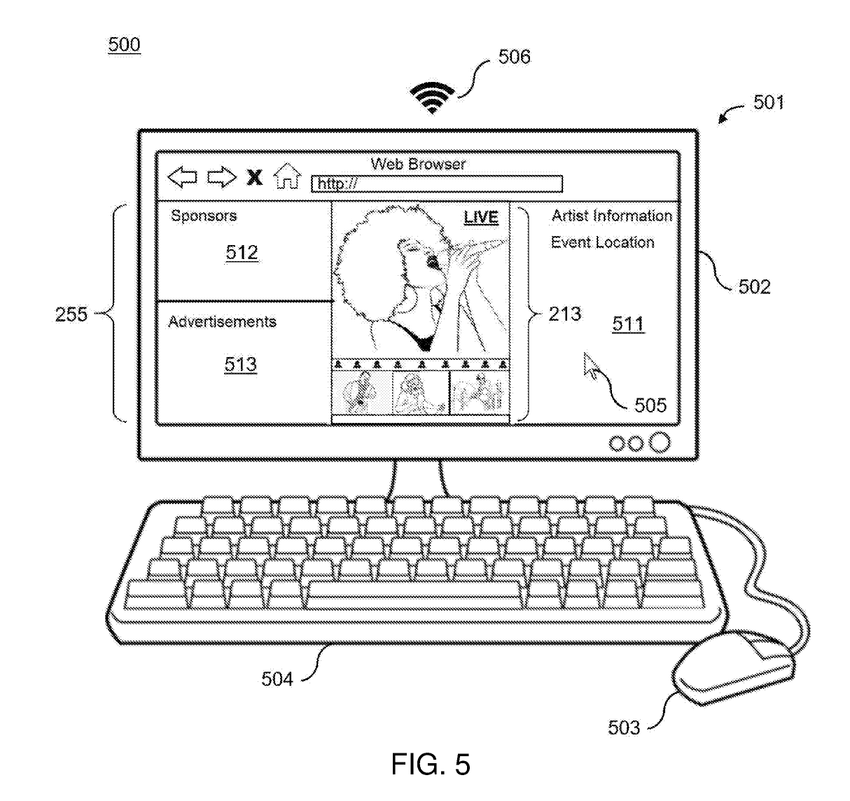

Viewers 240, who may be present at the same live event as streamers 205, may use mobile application 212 installed on mobile devices 110 to view live video content recorded by streamers 205 and transmitted by server 220 by way of network 260. Remote viewers 250, who may not be present at the same live event as streamers 205 or viewers 240, may use mobile application 212 installed on mobile devices 110 to view live video content recorded by streamers 205 and transmitted by server 220 by way of network 260. In another embodiment, remote viewers 250, who may not be present at the same live event as streamers 205 or viewers 240, may use an Internet browser-based version of mobile application 212, such as, e.g., a website 255, accessed by an Internet browser utility installed on a desktop device 501, such as, e.g., a desktop computer or laptop computer, equipped with an network connection, such as, e.g., a wireless Internet connection 506, to view live video content recorded by streamers 205 and transmitted by server 220 by way of network 260, as explained in FIGS. 5 and 7. Website 255 may be a version of mobile application 212 adapted for desktop devices, and website 255 may include a similar graphical user interface 213 as that included in mobile application 212.

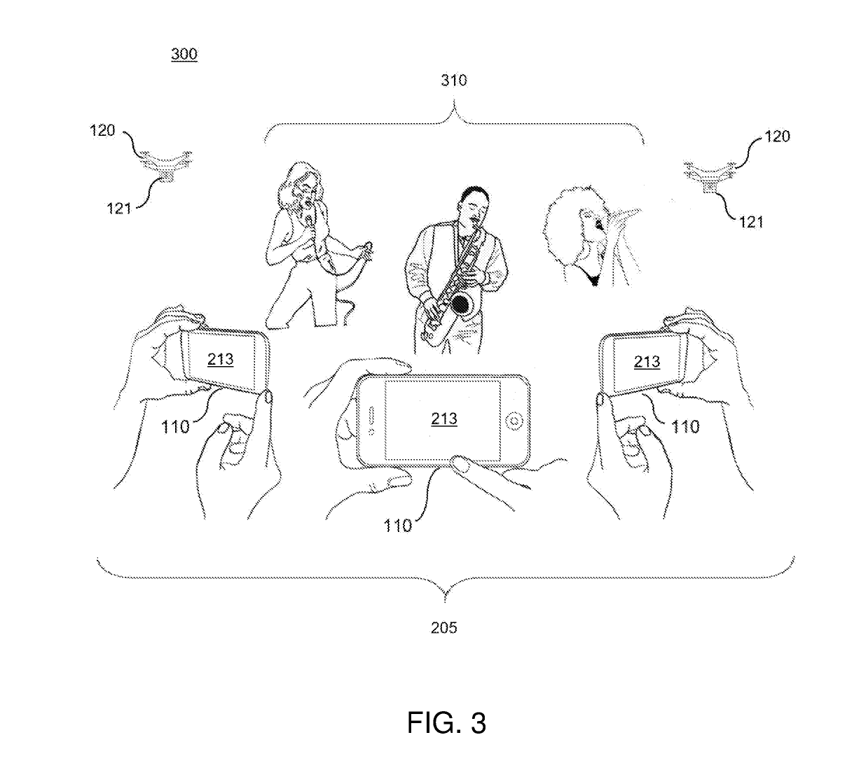

FIG. 3 illustrates a front view of a live video streaming system 300, which may include a plurality of streamers 205 using mobile application 212 and method of recording and transmitting, or “streaming,” live video content 600 of the subject disclosure in conjunction with a plurality of mobile devices 110 to record, transmit, or together “stream,” and view a plurality of live performers 310. Streamers 205 may be situated in different areas in the vicinity of live performers 310, and their respective locations may provide advantages in recording live performers 310, such as, e.g., different viewing angles, closer proximity to certain live performers 310, a better view of the entire live event and other spectators, or higher quality audio or video recordings of live performers 310. Streamers 205 may use graphical user interface 213, as explained in FIG. 4, to view live video content from other streamers 205 while simultaneously recording and transmitting, or “streaming,” live video content from their mobile devices 110.

In another embodiment, live performers 310 and other facets of a live event may be recorded using camera and microphone assemblies 121 of remotely-controlled aerial systems 120, which may be controlled by mobile devices 110 equipped with mobile application 212 of the subject disclosure. Live video content streamed from a plurality of cameras 113 on mobile devices 110, and camera and microphone assemblies 121 on remotely-controlled aerial systems 120, may be merged by server 220 and transmitted to mobile application 212 as a continuous collection, or “stream,” of live video content from the same live event in any suitable manner known in the art, such as, e.g., by streamers 205 selecting the live event they are attending from a list of predetermined locations or live events saved on a server 220 connected to mobile application 212, or by mobile application 212 determining the location of a streamer 205 by receiving location data, such as, e.g., latitude, longitude, and altitude coordinates, from mobile device 110 by way of mobile device feature interface 214 communicating with a global positioning satellite or “GPS” utility installed on mobile device 110, and comparing received location data to a list of nearby locations or live events. Streamers 205, along with viewers 240 at the same live event, may use graphical user interface 213, explained in FIG. 4, of mobile application 212 to view live video content from all streamers 205 transmitting, or “streaming,” live video content from that live event to server 220 connected to mobile application 212.

FIG. 4 illustrates a front view of a live video viewing system 400, which may include a graphical user interface (GUI) 213 as an example implementation of a feature of mobile application 212 of the subject disclosure installed on mobile device 110. It should be noted that graphical user interface 213 as shown in FIG. 4 is for illustrative purposes only, and that additional configurations and functionalities may be incorporated without diverging from this embodiment and the subject matter of the present disclosure. Graphical user interface 213 may display any suitable content known in the art, such as, e.g., graphical, video, advertising, networking, communication, sponsor, or other content, in any suitable arrangement known in the art, such as, e.g., a primary video panel 402, one of more secondary video panels 403, an online user panel 404, and an advertisement panel 405. Graphical user interface 213 may also include features that may allow viewers 240 to pause, rewind, or resume live video content displayed in primary video panel 402 or secondary video panels 403.

In one example, primary video panel 402 may display a live video stream; the plurality of secondary video panels 403 may display thumbnails of other live video streams from the same live event; online user panel 404 may display a list of names, numbers, icons, or thumbnails of photographs or videos representing other viewers 240, remote viewers 250, or streamers 205 viewing live video content from the same live event; and advertisement panel 405 may display images, logos, trademarks, hyperlinks, or other advertising content.

In one embodiment, live video “streams” from a plurality of streamers 205 may be continuously recorded and transmitted, or “streamed,” to server 220 by way of network 260, and then continuously transmitted to mobile application 212 on mobile device 110 from server 220 by way of network 260, and the streams may be displayed in some combination of primary video panel 402 and one or more secondary video panels 403 in any suitable manner known in the art, such as, e.g., with the relative positions of the live video streams in graphical user interface 213 being determined by a ranking of the live video streams' video quality numbers as determined by algorithm 225 on server 220, as explained in FIGS. 2, 6, and 7.

For example, live video stream 403a may be displayed in primary video panel 402, live video stream 403b may be displayed in one of a plurality of secondary video panels 403, and other live video streams may be displayed in the remaining of a plurality of secondary video panels 403. In another example, live video stream 403a, which may have the highest video quality number among all available live video streams from a certain live event, may be automatically displayed by mobile application 212, which may have an “automatic mode” or “optimal mode” enabled, in primary video panel 402, and live video stream 403b and other live video streams from the same live event may be displayed in secondary video panels 403 according to the rank of their video quality numbers, as explained in FIGS. 2, 6, and 7.

In yet another embodiment, a viewer 240, which may have disabled the “automatic mode” or “optimal mode” of mobile application 212, may toggle which of a plurality of live video streams may be displayed in primary video panel 402, which may have any conceivable preferred features known in the art compared to secondary video panels 403, such as, e.g., a larger viewing area than secondary video panels 403 or additional social media features, by using any suitable pointing implement 406 known in the art, such as, e.g. a finger, stylus, or verbal command used in conjunction with a voice-activated feature of mobile device 110 initiated by mobile application 212 by way of mobile device feature interface 214, to select one of a plurality of live video streams displayed in one of a plurality of secondary video panels 403.

For example, as shown in FIG. 4, if live video stream 403b is currently displayed in primary video panel 402 and live video stream 403a is currently displayed in one of a plurality of secondary video panels 403, viewer 240 may use pointing implement 406, such as, e.g., a finger, stylus, voice, in any suitable manner known in the art, such as, e.g., by touch, click, voice command, blink, facial expression, other suitable biometric signal, or other indication, to select live video stream 403a, which may result in live video stream 403a subsequently being displayed in primary video panel 402, and live video steam 403b subsequently being displayed in one of a plurality of secondary video panels 403, where live video stream 403a was previously displayed before viewer 240 toggled live video streams 403a and 403b.

FIG. 5 illustrates a front view of a live video remote viewing system 500, which may allow remote viewers 250 to use desktop devices 501 to access an Internet browser-based or website 255 version of mobile application 212 of the subject disclosure to view live video content recorded and transmitted, or “streamed,” by streamers 205 at a live event. Live video remote viewing system 500 may include a desktop device 501, such as, e.g., a personal computer or a laptop computer, which may include a desktop device display area 502, such as, e.g., a computer monitor screen; a desktop pointing device 503, such as, e.g., a computer mouse or computer pen; a desktop typing device 504, such as, e.g., a computer keyboard; a desktop device display area position indicator 505, such as, e.g., a computer screen cursor; and a network connection 506, such as, e.g., an Internet connection.

Website 255 may include a performance information panel 511, a sponsor information panel 512, an advertisement panel 513, and a graphical user interface 213. Graphical user interface 213 may display any suitable content known in the art, such as, e.g., graphical, video, advertising, networking, communication, sponsor, or other content, in any suitable arrangement known in the art, such as, e.g., a plurality of panels. In one embodiment, graphical user interface 213 may display information in a primary video panel 402, one of more secondary video panels 403, an online user panel 404, and an advertisement panel 405, as explained in FIG. 4. In one example, primary video panel 402 may display a live video stream; the plurality of secondary video panels 403 may display thumbnails of other live video streams from the same live event; online user panel 404 may display a list of names, numbers, icons, or thumbnails of photographs or videos representing other viewers 240, remote viewers 250, or streamers 205 viewing live video content from the same live event; and advertisement panel 405 may display images, logos, trademarks, hyperlinks, or other advertising content.

Although remote viewer 250 using website 255 on desktop device 501 may not be able to record and transmit, or “stream,” live video content from the location of the live event, as described in FIGS. 1 and 3, due to remote viewer 250 not being physically present at the location of the live event, remote viewer 250 may use graphical user interface 213 to select between and view the plurality of live video content recorded and transmitted, or “streamed,” by streamers 205 at the location of the live event, similar to how viewers 240 at the live event may view live video content using graphical user interface 213 of mobile application 212. In one embodiment, part of website 255 may include the same or a similar graphical user interface 213 as the one that may be included in mobile application 212 installed on mobile devices 110 and used by streamers 205 and viewers 240.

As explained for streamer 205 in FIG. 1, remote viewer 250 may initialize website 255 in any suitable manner known in the art, such as, e.g., by using desktop pointing device 503, such as, e.g., a computer mouse or computer pen, to maneuver desktop device display area position indicator 505 to select, such as, e.g., by manually clicking upon, an icon representing website 255 on desktop device display area 502; by using desktop typing device 504 to direct an Internet browser utility installed on desktop device 501 to open website 255 in desktop device display area 502, or, if desktop device display area 502 is a touchscreen, by manually clicking desktop device display area 502 with a pointing implement 406, such as, e.g., a finger or stylus.

Once initialized, website 255 may prompt remote viewer 250 to select a location or live event from which remote viewer 250 intends to view live video content, in any suitable manner known in the art, such as, e.g., by using desktop pointing device 503 to maneuver desktop device display area position indicator 505 to select, such as, e.g., by manually clicking upon, the location of the live event from among a list of predetermined locations or live events saved on server 220 connected to website 255, or, alternatively, by using desktop typing device 504 to manually input the name of the location or live event into a search engine feature of a list of predetermined locations or live events saved on server 220. In another embodiment, website 255 may populate a list of locations or live events by matching the Internet Protocol or “IP” address of desktop device 501 to nearby locations or live events.

Once remote viewer 250 selects a location or live event, website 255 may display a plurality of live video content recorded and transmitted, or “streamed,” by a plurality of streamers 205 at the location or live event to server 220 by way of network 260, and subsequently transmitted to desktop device 501 from server 220 by way of network 260 and network connection 506, such as, e.g., a wired or wireless network connection to Internet enabled or installed on desktop device 501. Once the plurality of live video content is displayed on website 255, as explained above, remote viewer 250 may toggle which live video stream is displayed in primary video panel 402 by any suitable manner known in the art, such as, e.g., by manually touching an area of website 255 as displayed on desktop device display area 502, such as, e.g., a capacitive or resistive touchscreen, corresponding with a certain live video stream, or by using desktop pointing device 503, such as, e.g., a computer mouse or computer pen, in conjunction with desktop device display area position indicator 505, to select one among a plurality of live video streams displayed in one of a plurality of secondary video panels 403 displayed elsewhere on website 255 on desktop device display area 502. Doing so may result in the live video stream in the indicated secondary video panel 403 switching places with the live video stream displayed in primary video panel 402, as explained in FIG. 4.

Alternatively, remote viewer 250 may enable a setting or feature of website 255, such as, e.g., an “automatic mode” or “optimal mode,” as explained in FIGS. 4 and 7, that may automatically display preferred or optimal live video content, as determined by algorithm 225, in primary video panel 402, based on predetermined characteristics or criteria, such as, e.g., video quality; audio quality; audio volume; preferred angles or viewpoints, such as, e.g., high-altitude footage recorded by remotely-controlled aerial systems 120 or “drones;” the location of persons and objects at the live event, such as, e.g., celebrities, players, and the ball itself at a live sporting event; and availability of streamed content from certain streamers, such as, e.g., celebrities or spectators with on-stage or backstage access to the live event. In addition, remote viewers 250 may view master video files 232, which may include one or more compilations of preferred or optimal live video content from the location or live event, such as, e.g., “master recordings” of the live video content with the highest available video quality numbers at each interval of the live event, as determined by algorithm 225, that may be stored in data storage 230 on server 220 for subsequent access and observation by streamers 205, viewers 240, and remote viewers 250.

FIG. 6 illustrates a flow chart diagram of a method 600 of recording and transmitting, or “streaming,” a plurality of live video content using mobile application 212 of the subject disclosure. In step S601, the method starts. In step S602, a streamer 205 may initialize mobile application 212 on a mobile device 110, such as, e.g., a smartphone, tablet computer, wristwatch-style or otherwise wearable computer, or other Internet-connected computing device, in any suitable manner known in the art, such as, e.g., by clicking on a mobile application icon 112 on the mobile device display area 111 of mobile device 110 with a pointing implement 406, such as, e.g., a finger, stylus, or verbal command in conjunction with a voice-operated utility of mobile device 110.

In step S603, mobile application 212 may establish a connection to a server 220 by any suitable method known in the art, such as, e.g. by way of connection to a network 260, such as, e.g., the Internet, using a mobile device feature interface 214 of mobile device 110, and then communicating with server 220 by way of network 260. Network 260 may include any suitable devices or utilities known in the art, such as, e.g., computer hardware, software, or firmware adapted to transmit data by analog or digital signals by and between computing devices. Server 220 may consist of any suitable devices or utilities known in the art, such as, e.g., a data storage 230, which may store information, such as, e.g., user profiles 231 related to streamers 205, viewers 240, and remote viewers 250 that use mobile application 212. Server 220 may also consist of master video files 232, which may include, such as, e.g., one or more optimal compilations or “master recordings” selected from among a plurality of live video content transmitted to server 220 by streamers 205 using mobile application 212, based on evaluations, comparisons, and rankings by an algorithm 225, according to predetermined characteristics or criteria of the live video content, on server 220. Server 220 may be in any suitable device, means, or embodiment known in the art, such as, e.g., a physical computer server or a cloud computing server.

In step S604, mobile application 212 may authenticate streamer 205, as well as settings for streamer 205, such as, e.g., live event preferences and type of mobile device 110 associated with streamer 205, by any suitable method known in the art, such as, e.g. by receiving information provided by streamer 205, by any suitable method known in the art, such as, e.g., using a login and password, or other typed, voice-activated, or biometrically scanned information, such as, e.g., fingerprint or facial recognition information, and comparing the received information to user profiles 231 stored on data storage 230 of server 220.

In step 605, mobile application 212 may determine the present location of streamer 205, using any suitable method known in the art, such as, e.g., by receiving information collected by a global positioning satellite or “GPS” utility of mobile device 110 as accessed by mobile application 212 using mobile device feature interface 214. In one embodiment, mobile application 212 may compare the location information, such as, e.g., latitude, longitude, and altitude coordinates, received from streamer 205 with live event data present on data storage 230 of server 220, or received from network 260, such as, e.g., the Internet, to match the location of streamer 205 to a list of predetermined live events in the vicinity of that location. This information may be used in any suitable manner known in the art, such as, e.g., to aggregate live video content recorded and transmitted, or “streamed,” by streamers 205 at the same live event.

In step S606, streamer 205 may initialize a live stream feature of mobile application 212, by any suitable method known in the art, such as, e.g., by using a pointing implement 406, such as, e.g., a finger or stylus, to navigate a graphical user interface 213 of mobile application 212 to select a live event from which to view live video content on mobile device display area 111. In one embodiment, streamer 205 may select a live event from a list, which may be displayed on graphical user interface 213 of application 212, of predetermined live events with live video content being streamed to server 220, which may be accessed using mobile application 212.

In step S607, if streamer 205 wants to record and transmit, or “stream,” live video content, in addition to viewing the currently available live video content, streamer 205 may use graphical user interface 213 to direct mobile application 212 to initialize one or more cameras 113 on mobile device 110, using a mobile device feature interface 214 on mobile device 110. In another embodiment, mobile application 212 may initialize an aerial camera 121 on a remotely-controlled aerial system 120, commonly known as an unmanned aerial vehicle, or “drone.”

In step S608, streamer 205 may record live video content by any suitable method known in the art, such as, e.g., by using one or more cameras 113, flashes 114, and microphones 115 of mobile device 110, or, alternatively or in addition, by using one or more aerial cameras 121 of one or more remotely-controlled aerial systems 120.

In step S609, mobile application 212 may compress and buffer live video content, in any suitable manner known in the art, such as, e.g. by using a combination of video compression algorithms, encoders, spatial image compression, and temporal motion compensation, along with storage utilities on mobile application 212 or mobile device 110, to accomplish, for example, lossy or lossless compression.

In step S610, continuously and practically simultaneously with steps S608 and S609, mobile application 212 may transmit buffered live video content to server 220 in any suitable manner known in the art, such as, e.g. by using a mobile device feature interface 214 of mobile device 110 to initialize a network connection utility of mobile device 110 to connect to network 260, and communicate with server 220 by way of a network 260, such as, e.g., the Internet. Network 260 may include any suitable devices or utilities known in the art, such as, e.g., computer hardware, software, or firmware adapted to transmit data by analog or digital signals by and between computing devices.

In step S611, server 220 may authenticate live video content, in any suitable manner known in the art, such as, e.g., by comparing user data, location data, digital hash values, forensics watermarking, digital encryption data, key server data, or digital rights management information associated with the live video content.

In step S612, server 220 may decompress live video content, in any suitable manner known in the art to reverse the compression accomplished in step S609, such as, e.g., by using a combination of analogs to the video compression algorithms, encoders, spatial image compression, and temporal motion compensation utilities used in step S609, along with storage utilities on mobile application 212 or mobile device 110, to accomplish, for example, the reversal of lossy or lossless compression.

In step S613, algorithm 225 on server 220 may evaluate the quality of the live video content and assign a ranking, such as, e.g., a “video quality number,” to the live video content. The video quality number may be determined based on any suitable parameters, such as, e.g., predetermined characteristics or criteria, such as, e.g., video quality; audio quality; audio volume; preferred angles or viewpoints, such as, e.g., high-altitude footage recorded by remotely-controlled aerial systems 120 or “drones;” the location of persons and objects at the live event, such as, e.g., celebrities, players, and the ball itself at a live sporting event; and availability of streamed content from certain streamers 205, such as, e.g., celebrities or spectators with on-stage or backstage access to the live event. In one embodiment, the video quality number may be a number from 0 to 100, which may represent higher quality videos with higher numbers.

In step S614, server 220 may merge live video content with other live video content recorded and transmitted, or “streamed,” by other streamers 205 at the same location or live event by any suitable method known in the art, such as, e.g., by matching location information on server 220 with location data, such as, e.g., latitude, longitude, and altitude coordinates, received by mobile application 212 from mobile device 110 by way of mobile device feature interface 214 communicating with a global positioning satellite or “GPS” utility installed on mobile devices 110 of streamers 205, and transmitted by mobile application 212 to server 220.

In step S615, server 220 may transmit live video content to viewers 240 at the same live event as streamer 205, and to remote viewers 250, by way of network 260, until streamer 205 terminates mobile application 212 on mobile device 110.

In step S616, server 220 may store video content with the highest video quality numbers at each interval of a live event, as determined by algorithm 225 from among all live video content recorded and transmitted, or “streamed,” from the live event, into one or more master video files 232 in data storage 230 on server 220 for later viewing by streamers 205, viewers 240, and remote viewers 250.

FIG. 7 illustrates a flow chart diagram of a method 700 of viewing a plurality of live video content using mobile application 212 of the subject disclosure. In step S701, the method starts. In step S702, a viewer 240 may initialize mobile application 212 on a mobile device 110, such as, e.g., a smartphone, tablet computer, wristwatch-style or otherwise wearable computer, or other Internet-connected computing device, by any method known in the art, such as, e.g., by clicking on a mobile application icon 112 on the mobile device display area 111 of mobile device 110 with a pointing implement 406, such as, e.g., a finger, stylus, or verbal command conjunction with a voice-operated utility of mobile device 110. Viewer 240 may then log into mobile application 212 in any suitable manner known in the art, such as, e.g., by inputting username and password information into mobile application 212.

Alternatively, a remote viewer 250 may access an Internet browser-based or website 255 version of mobile application 212 on a desktop device 501, such as, e.g., a desktop computer or laptop computer, in any suitable manner known in the art, such as, e.g., by using desktop pointing device 503, such as, e.g., a computer mouse or computer pen, to maneuver a desktop device display area position indicator 505 to select, such as, e.g., by manually clicking on, an icon representing website 255 on desktop device display area 502, such as, e.g., a computer monitor screen, or by using desktop typing device 504, such as, e.g., a computer keyboard, to direct an Internet browser utility installed on desktop device 501 to open website 255 in desktop device display area 502. Remote viewer 250 may then log into mobile application 212 in any suitable manner known in the art, such as, e.g., by inputting username and password information into website 255.

In step S703, mobile application 212 may authenticate viewer 240 as well as user settings for viewer 240, such as, e.g., live event preferences and type of mobile device 110 used by viewer 240. Mobile application 212 may authenticate viewer 240 by any suitable method known in the art, such as, e.g. by comparing information inputted by viewer 240 to information in user profiles 231 stored in data storage 230 on server 220, or by any suitable biometric authentication method known in the art, such as, e.g., fingerprint or facial recognition. Alternatively, website 255 may authenticate remote viewer 250 as well as user settings for remote viewer 250, such as, e.g., live event preferences and type of desktop device 501 used by remote viewer 250. Website 255 may authenticate remote viewer 250 by any suitable method known in the art, such as, e.g. by comparing information inputted by remote viewer 250 to information in user profiles 231 stored in data storage 230 on server 220, or by any suitable biometric authentication method known in the art, such as, e.g., fingerprint or facial recognition.

In step S704, viewer 240 may use any suitable pointing implement 406 known in the art, such as, e.g. a finger, stylus, or voice command used in conjunction with a voice-activated utility of mobile device 110 initiated by mobile application 212 by way of mobile device feature interface 214, to select the location or live event from which viewer 240 intends to view live video content from a list of predetermined locations or events saved on a server 220 connected to mobile application 212. Alternatively, viewer 240 may select from a list of locations and live events populated by mobile application 212 receiving location data, such as, e.g., latitude, longitude, and altitude coordinates, from mobile device 110 by way of mobile device feature interface 214 communicating with a global positioning satellite or “GPS” utility installed on mobile device 110, and then mobile application 212 comparing received location data to a list of nearby locations or events.

Alternatively, remote viewer 250 may select the location or live event from which to view live video content in any suitable manner known in the art, such as, e.g., by using desktop pointing device 503, such as, e.g., a computer mouse or computer pen, to maneuver desktop device display area position indicator 505, such as, e.g., a computer screen cursor, to select, such as, e.g., by manually clicking on, the location or live event from among a list of predetermined locations or live events saved on server 220 connected to website 255. Alternatively, remote viewer 250 may use desktop typing device 504, such as, e.g., a desktop keyboard, to manually input the name of the location or live event into a search engine feature of the list of predetermined locations or live events saved on server 220. In another embodiment, website 255 may populate a list of locations or live events by matching an Internet Protocol or “IP” address of desktop device 501 to nearby locations or live events, and remote viewer 250 may select a location or live event from this list.

In step S705, server 220 may compress live stream videos in any suitable manner known in the art, such as, e.g., by using a combination of video compression algorithms, encoders, spatial image compression, and temporal motion compensation, along with storage utilities on mobile application 212 or mobile device 110, to accomplish, for example, lossy or lossless compression.

In step S706, algorithm 225 on server 220 may evaluate the quality of the live video content and may assign a ranking, such as, e.g., a “video quality number” to the live video content. The video quality number may be determined based on any suitable parameters, such as, e.g., predetermined characteristics or criteria, such as, e.g., video quality; audio quality; audio volume; preferred angles or viewpoints, such as, e.g., high-altitude footage recorded by remotely-controlled aerial systems 120 or “drones;” the location of persons and objects at the live event, such as, e.g., celebrities, players, and the ball itself at a live sporting event; and availability of streamed content from certain streamers 205, such as, e.g., celebrities or spectators with on-stage or backstage access to the live event. In one embodiment, the “video quality number” may be a number from 0 to 100, which may represent higher quality videos with higher numbers.

In step S707, server 220 may transmit live video content from a plurality of streamers 205 at the same location or live event to viewers 240 using mobile application 212, and remote viewers 250 using website 255, as thumbnails, by way of network 260.

In step S708, mobile application 212 or website 255 may receive thumbnails of live video content, with respective video quality numbers assigned by algorithm 225, from server 220 by way of network 260.

In step S709, mobile application 212 or website 255 may rank thumbnails of live video content in any suitable manner known in the art, such as, e.g., by numerically ordering the live video content based on the video quality numbers assigned by algorithm 225, or by comparing characteristics of the live video content to preferences of viewer 240 or remote viewer 250 reflected in user profiles 231 stored in data storage 230 on server 220.

In step S710, mobile application 212 or website 255 may decompress live video content in any suitable manner known in the art to reverse the compression accomplished in step S705, such as, e.g., by using a combination of analogs to the video compression algorithms, encoders, spatial image compression, and temporal motion compensation utilities used in step S705, along with storage utilities on mobile application 212 or mobile device 110, to accomplish, for example, the reversal of lossy or lossless compression.

In step S711, mobile application 212 or website 255 may determine whether viewer 240 or remote viewer 250, respectively, has enabled an “automatic mode” or “optimal mode” of mobile application 212 or website 255. If so, the method may proceed to step S712. If not, the method may proceed to step S713.

In step S712, mobile application 212 or website 255 may automatically display the live video content of the highest quality, as determined in any suitable manner known in the art, such as, e.g., based on the video quality numbers assigned to the plurality of live video content by algorithm 225 in step S706, in primary video panel 402 of graphical user interface 213, and the method may proceed to step S714.

In step S713, viewer 240, as explained in FIG. 4, may toggle which of a plurality of live streams may be displayed in primary video panel 402, which may have any conceivable preferred features known in the art compared to secondary video panels 403, such as, e.g., a larger viewing area than secondary video panels 403 or additional social media features, by using any suitable pointing implement 406 known in the art, such as, e.g. a finger, stylus, or voice command used in conjunction with a voice-activated feature of mobile device 110 initiated by mobile application 212 by way of mobile device feature interface 214, to select one of a plurality of live video streams displayed in one of a plurality of secondary video panels 403 on mobile device display area 111, and the method may proceed to step S714.

Alternatively, remote viewer 250, as explained in FIGS. 4 and 5, may toggle which of a plurality of live streams may be displayed in primary video panel 402, which may have any conceivable preferred features known in the art compared to secondary video panels 403, such as, e.g., a larger viewing area than secondary video panels 403 or additional social media features, by using desktop pointing device 503, such as, e.g., a computer pen or computer mouse, in conjunction with desktop device display area position indicator 505, such as, e.g., a computer screen cursor, to select one of a plurality of live video streams displayed in one of a plurality of secondary video panels 403 on desktop display area 502 of desktop device 501, and the method may proceed to step S714.

In step S714, mobile application 212 or website 255 may display live video content in graphical user interface 213 on mobile device display area 111 or desktop device display area 502.

In step S715, viewer 240 or remote viewer 250 may determine whether to discontinue viewing live video content on mobile application 212 or website 255, respectively. If not, the method may proceed to step S711. If so, the method may proceed to step S716.

In step S716, viewer 240 may terminate mobile application 212 on mobile device 110. Alternatively, remote viewer 250 may terminate website 255 on desktop device 501.

Overall, mobile application 212; systems 100, 200, 300, 400, and 500; and methods 600 and 700 of the subject disclosure may provide advantages over applications, devices, systems, or methods currently known in the art. Specifically, mobile application 212; systems 100, 200, 300, 400, and 500; and methods 600 and 700 may provide more flexible, customizable, crowdsourced, and immediate viewing experiences to virtually infinite audiences, by allowing users to instantly record, transmit, or together “stream,” and view a multitude of live video content from live events, and store optimized compilations or “master recordings” of video content extracted from a multitude of streamers at the same live event, with significantly less delay and cost, and without professional training in video directing or editing.

The illustrations and examples provided herein are for explanatory purposes and are not intended to limit the scope of the appended claims. It will be recognized by those skilled in the art that changes or modifications may be made to the above described embodiments without departing from the broad inventive concepts of the subject disclosure. It is understood, therefore, that the subject disclosure is not limited to the particular embodiments which are described, but is intended to cover all modifications and changes within the scope and spirit of the subject disclosure.

What is claimed is:

1. A method in one or more mobile devices, comprising:
initializing a mobile application installed on one or more mobile devices;
establishing a connection to a server;
authenticating one or more users of the mobile application;
determining the location of the one or more users;
initializing a recording feature of the mobile application;
initializing one or more recording devices connected to the one or more mobile devices;
recording audiovisual content using the one or more recording devices;
compressing the audiovisual content;
buffering the audiovisual content;
transmitting the audiovisual content to the server;
authenticating the audiovisual content;
decompressing the audiovisual content;
evaluating the audiovisual content;
ranking the audiovisual content;
aggregating the audiovisual content with other audiovisual content transmitted to the server by the one or more users of the mobile application;
transmitting the audiovisual content to one or more computing devices equipped with the mobile application;
displaying the audiovisual content on the one or more computing devices;
determining whether or not the mobile application has terminated; and
storing one or more compilations of the audiovisual content.

2. The method of claim 1, wherein the audiovisual content is live.

3. The method of claim 1, wherein the one or more recording devices is connected to one or more remotely-controlled aerial systems.

4. The method of claim 1, wherein the audiovisual content is recorded by a plurality of users of the mobile application at the same location.

5. The method of claim 1, wherein the audiovisual content is evaluated and ranked by an algorithm on the server, the algorithm being configured to evaluate and rank the plurality of audiovisual content based on predetermined criteria.

6. The method of claim 5, wherein the predetermined criteria are video quality of the audiovisual content, audio quality of the audiovisual content, audio volume of the audiovisual content, location of the user recording the audiovisual content, location of the device recording the audiovisual content, location of persons at the live event, location of objects at the live event, and the identity of the user recording the audiovisual content.

7. The method of claim 6, further comprising an automatic feature of the mobile application, wherein the mobile application automatically changes the arrangement of the plurality of audiovisual content displayed on the one or more computing devices, based on one or more rankings assigned to the audiovisual content by the algorithm.

8. The method of claim 1, wherein the mobile application changes the arrangement of the plurality of audiovisual content displayed on the one or more computing devices according to user input.

9. The method of claim 1, wherein the one or more compilations of audiovisual content is composed of the audiovisual content with the highest ranking at each interval of a live event, as determined by the algorithm from among a plurality of audiovisual content from the live event.

10. A method in one or more computing devices, comprising:
initializing a mobile application on one or more computing devices;
authenticating one or more users of the mobile application;
selecting a location from among a plurality of locations;
compressing audiovisual content;
evaluating audiovisual content;
transmitting audiovisual content;
receiving audiovisual content;
ranking audiovisual content;
decompressing audiovisual content;
displaying audiovisual content on one or more computing devices; and
determining whether or not the mobile application has terminated.

11. The method of claim 10, wherein the mobile application is a website accessible by one or more stationary computing devices.

12. The method of claim 10, wherein the audiovisual content is live.

13. The method of claim 10, further comprising determining whether an automatic mode of the mobile application is enabled.

14. The method of claim 13, wherein the automatic mode of the mobile application automatically changes the arrangement of a plurality of audiovisual content displayed on the one or more computing devices based on rankings of the plurality of audiovisual content.

15. The method of claim 10, further comprising changing the arrangement of a plurality of audiovisual content displayed on the one or more computing devices based on user input.

16. The method of claim 10, wherein the one or more computing devices equipped with the mobile application are located at a plurality of locations, including the location where the audiovisual content is being recorded.

17. A computer program product, the computer program product comprising a non-transitory computer readable storage medium having computer-usable program code embodied therewith, the computer-usable program code comprising:
computer-usable program code configured to initialize a mobile application on one or more mobile devices;
computer-usable program code configured to establish a connection to a server;
computer-usable program code configured to authenticate one or more users of the mobile application;
computer-usable program code configured to determine the location of the one or more users;
computer-usable program code configured to initialize a recording feature of the mobile application;
computer-usable program code configured to initialize one or more recording devices connected to the one or more mobile devices;
computer-usable program code configured to record audiovisual content using the one or more recording devices;
computer-usable program code configured to compress the audiovisual content;
computer-usable program code configured to buffer the audiovisual content;
computer-usable program code configured to transmit the audiovisual content to the server;
computer-usable program code configured to authenticate the audiovisual content;
computer-usable program code configured to decompress the audiovisual content;
computer-usable program code configured to evaluate the audiovisual content;
computer-usable program code configured to rank the audiovisual content;
computer-usable program code configured to aggregate the audiovisual content with other audiovisual content transmitted to the server by the one or more users of the mobile application;
computer-usable program code configured to transmit the audiovisual content to one or more computing devices equipped with the mobile application;
computer-usable program code configured to display the audiovisual content on the one or more computing devices;
computer-usable program code configured to determine whether or not the mobile application has terminated; and
computer-usable program code configured to store one or more compilations of the audiovisual content.

18. A system for recording, transmitting, viewing, and storing live audiovisual content, comprising:
one or more computing devices, comprising:
one or more recording devices;
one or more output devices;
one or more sensors for detecting events; and
one or more transceivers for transmitting and receiving wireless data;
one or more remotely-controlled aerial devices, comprising:
one or more aerial recording devices;
one or more networks;
one or more servers, comprising:
one or more algorithms, wherein the one or more algorithms are adapted to evaluate and rank audiovisual content; and
one or more data storages, comprising:
one or more profiles of users of the mobile application; and
one or more compilations of audiovisual content; and
a mobile application, comprising:
one or more graphical user interfaces;
one or more computing device feature interfaces, wherein the one or more computing device feature interfaces are adapted to control the one or more recording devices, the one or more aerial recording devices, and the one or more transceivers; and
one or more program instructions, wherein executing the program instructions causes the one or more computing devices to:
initialize the mobile application on the one or more computing devices;
establish a connection to the one or more servers;
authenticate one or more users of the mobile application;
determine the location of the one or more users;
initialize a recording feature of the mobile application;
initialize the one or more recording devices connected to the one or more computing devices;
record audiovisual content;
compress audiovisual content;
buffer audiovisual content;
transmit audiovisual content to the one or more servers;
authenticate the audiovisual content;
decompress the audiovisual content;
evaluate the audiovisual content;
rank the audiovisual content;
aggregate the audiovisual content with other audiovisual content;
transmit the plurality of audiovisual content to the one or more computing devices equipped with the mobile application;
display the audiovisual content on the one or more computing devices;
determine whether or not the mobile application has terminated; and
store the one or more compilations of the audiovisual content.

19. The one or more graphical user interfaces of claim 18, wherein the one or more graphical user interfaces is adapted to display audiovisual content on the one or more output devices of the one or more computing devices, receive user input, and change the arrangement of the audiovisual content displayed on the one or more output devices of the one or more computing devices based on user input.

20. The one or more graphical user interfaces of claim 19, further comprising an automatic mode, wherein the automatic mode is adapted to automatically change the arrangement of the audiovisual content displayed on the one or more output devices of the one or more computing devices based on one or more rankings of the audiovisual content as determined by the one or more algorithms.
